(19) United States
(12) Patent Application Publication
(10) Pub. No.: US 2009/0265212 A1
(43) Pub. Date: Oct. 22, 2009

(54) ADVERTISING IN A STREAMING MEDIA ENVIRONMENT

(76) Inventors: DAVID HYMAN, Kensington, CA (US); ANDREI M. MARINESCU, San Francisco, CA (US)

Correspondence Address: Raj Abhyanker LLP, 1580 West, El Camino Real, Suite 8, Mountain View, CA, 94040, US

(21) Appl. No.: 12/104,466

(22) Filed: Apr. 17, 2008

(51) Int. Cl. G06Q 30/00

(52) U.S. Cl. 705/10; 705/14

(57) ABSTRACT

A method, system and apparatus of advertising in a streaming media environment are disclosed. In one embodiment, a method includes selecting a media content from a content database having content of a plurality of artists and media labels based on a request of a user of a social community environment, streaming the media content from a central server associated with the central database to the user without requiring consideration of the user to access the media content, and generating an advertisement that is displayed to the user when the media content is streamed to the user. The method may include selecting a good and/or a service being marketed in the advertisement based on an artist, an album, a track, a genre, a type, and/or a tempo of the media content and/or based on interests defined in a user profile associated with the user.

### FIELD OF TECHNOLOGY

This disclosure relates generally to the technical field of communications and, in one example embodiment, to a method, apparatus, and system of advertising in a streaming media environment.

### BACKGROUND

A user (e.g., a music fan, a movie patron, a computer gaming patron, an e-book reader) may purchase a media content (e.g., musical, theatrical, artistic, cultural, hobby, etc.) through a service (e.g., Apple® iTunes, Napster®, Rhapsody®, etc.). The service may charge a monthly subscription fee to the user to download the media content. The service may need to collect revenues to pay an artist, intermediaries, and/or employees of the service. The service may not allow unlimited access to the media content without charging the user a consideration (e.g., monthly fee, per unit download fee, subscription fee, etc.) to access the media content.

The user may not be able to afford the service. As a result, the media content may not be accessed by the user. As a result, the user may not develop a passion (e.g., a lively and/or eager admiration of a media form, and gratuitously promoting the media form with focused interest) for the media content. Furthermore, the user may illegally copy/download the media content. This may result in a lost opportunity in converting the user to a patron of the service.

### SUMMARY

A method, system and apparatus of advertising in a streaming media environment is disclosed. In one aspect, the method includes selecting a media content from a content database having content of a plurality of artists and media labels based on a request of a user of a social community environment, streaming the media content from a central server associated with the central database to the user without requiring consideration of the user to access the media content, and generating an advertisement (e.g., may be displayed in a drop-down banner adjacent to a location in the social community environment in which the user selected the media content) that is displayed to the user when the media content is streamed to the user.

The method may include selecting a good and/or a service being marketed in the advertisement based on an artist, an album, a track, a genre, a type, and/or a tempo of the media content and/or based on interests defined in a user profile associated with the user. The method may further include providing a bidding system in which different organizations providing advertisements bid against each other on placement and/or click through of their advertisements in a specific ones of the media content of the artists and at specific locations of the media content of the artists, and in which the different organizations select different profiles of users of the social community environment to target delivery of their advertisements.

The method may determine the advertisement that may be displayed based on an analysis of a click through rate on the advertisement by users of the social community environment and/or transaction rate of the users of the social community environment to whom the advertisement may be displayed. The method may allocate a portion of consideration of an organization providing the advertisement to an artist and/or a media label associated with the media content, and/or to the social community environment associated with the user.

An electronic message may be sent to the user after the media content is streamed and the advertisement may be displayed having an additional incentive to respond to the advertisement. The advertisement may be streamed to a client device that may be a mobile device, a desktop computer, a telephone, an Internet appliance, and/or an automobile, etc.

The method may also provide a server-side media player associated with the social community environment that may enable the user to stream the media content to the client device. The method may provide a widget of the server-side media player that may be embeddable across different websites (e.g., users of the different websites may be able to stream the media content along with the advertisement to their respective client devices from the central server through the different websites).

In addition, the method may include processing a transaction in which the user may purchase a downloadable copy of the media content. The method may communicate the downloadable copy of the media content to the client device when the transaction may be complete. The method may also include selecting a different advertisement to be displayed after the advertisement when the media content may be still being streamed to the client device (e.g., the different advertisement may be targeted toward any one of a beginning portion, an middle portion, an ending portion, and/or an arbitrary portion of the streaming of the media content). The method may further include orchestrating a visual motion and/or color scheme of the advertisement based on a tempo, a harmony, a rhythm, and/or a melody of the media content through a wave form analysis of the media content.

In another aspect, the method may include generating an advertisement that is targeted toward a user playing a streaming media content from a central server based on a characteristic of a media content currently being streamed and/or a meta-data of the advertisement, and providing a bidding mechanism to advertisers to compete for placement of the advertisement in streams of the media content to the user and to other users.

The method may include selecting a good and/or a service being marketed in the advertisement based on a closest match between the meta-data and an artist, an album, a track, a genre, a type, and/or a tempo of the streaming media content and/or based on interests defined in a user profile associated with the user. An electronic message may be sent to the user after the streaming media content is sent having an additional incentive to respond to the advertisement.

The method may also include processing a transaction in which the user may purchase a downloadable copy of the streaming media content. The method may communicate the downloadable copy of the streaming media content to a client device when the transaction is complete. The method may also include selecting a different advertisement to be displayed after the advertisement when the streaming media content is still being sent to the user (e.g., such that the different advertisement may be targeted towards any one of a beginning portion, an middle portion, an ending portion, and/or an arbitrary portion of the streaming media content). The method may include orchestrating a visual motion and/or color scheme of the advertisement based on a tempo, a harmony, a rhythm, and/or a melody of the streaming media content through a wave form analysis of the streaming media content).

In yet another aspect, the system includes a central server to stream a media content to a user and to select an advertisement to be simultaneously displayed with the media content being streamed, a content database associated with the central server having the media content and other media content of a plurality of artists and media labels based on a request of a user of a social community environment, and a client device to display an advertisement that is displayed to the user when the media content is streamed to the user without requiring consideration from the user to access the media content

The system may include a matching module of the central server to select any one of a good and a service being marketed in the advertisement based on a closest match between a meta-data and/or an artist, an album, a track, a genre, a type, and/or a tempo of the media content and/or based on interests defined in a user profile associated with the user. An electronic message may be sent to the user after the media content is sent having an additional incentive to respond to the advertisement.

The system may also include a financial module of the central server to process a transaction in which the user may purchase a downloadable copy of the media content being streamed. In addition, the system may include a delivery module of the central server to transmit the downloadable copy of the streaming media content to the client device when the transaction is complete.

The methods, system, and apparatuses disclosed herein may be implemented in any means for achieving various aspects, and may be executed in a form of machine-readable medium embodying a set of instruction that, when executed by a machine, causes the machine to perform any of the operation disclosed herein. Other features will be apparent from the accompanying drawing and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is system view of a user selecting the media data of his/her interest through a client device through a network, according to one embodiment.

FIG. 2 is an exploded view of streaming module illustrated in FIG. 1, according to one embodiment.

FIG. 3 is a user interface view of server-side media player, according to one embodiment.

FIG. 4 is a table view illustrating various fields such as streaming data, playlist, target ad, etc., according to one embodiment.

FIG. 5 is a diagrammatic system view of a data processing system in which any of the embodiments disclosed herein may be performed, according to one embodiment, according to one embodiment.

FIG. 6A is a process flow of determining advertisements that may be displayed based on analysis of a click through rate on the advertisements by users of a social community environment, according to one embodiment.

FIG. 6B is a continuation of process flow of FIG. 6A, illustrating additional operations, according to one embodiment.

FIG. 6C is a continuation of process flow of FIG. 6B, illustrating additional operations, according to one embodiment.

FIG. 7A is a process flow of generating an advertisement based on a streaming media content associated with a user, according to one embodiment.

FIG. 7B is a continuation of process flow of FIG. 7A, illustrating additional operations, according to one embodiment.

Other features of the present embodiments will be apparent from the description that follows.

### DETAILED DESCRIPTION

A method, apparatus and system of advertising in a streaming media environment are disclosed. In the following description, for the purposes of explanation, numerous specific details are set forth in order to provide a thorough understanding of the various embodiments. It will be evident, however to one skilled in the art that the various embodiments may be practiced without these specific details.

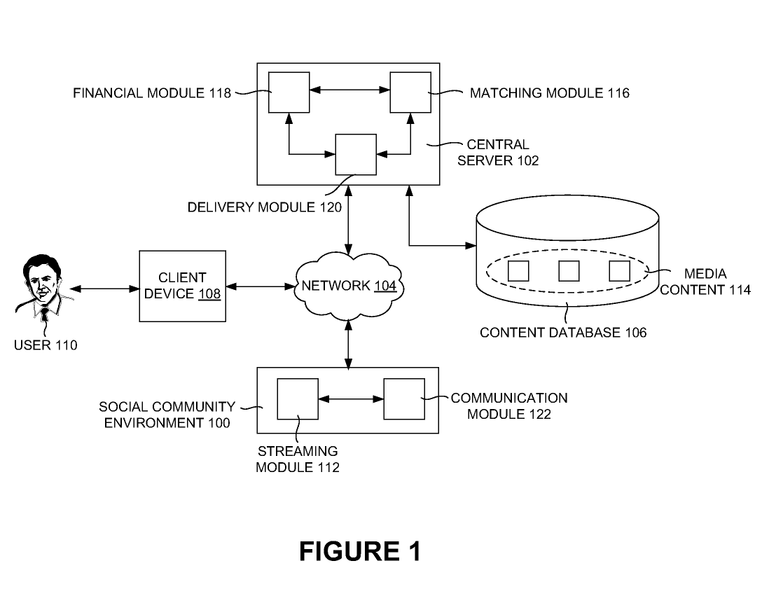

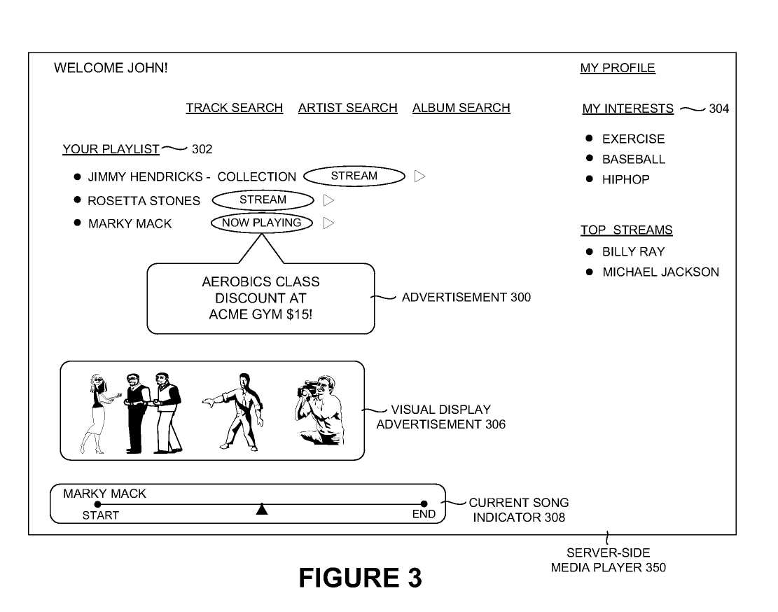

In one embodiment, the method includes selecting a media content (e.g., the media content 114 of FIG. 1) from a content database (e.g., the content database 106 of FIG. 1) having content of artists and media labels based on a request of a user (e.g., the user 110 of FIG. 1) of a social community environment (e.g., the social community environment 100 of FIG. 1), streaming the media content 114 from a central server (e.g., the central server 102 of FIG. 1) associated with the content database 106 to the user 110 without requiring consideration of the user 110 to access the media content 114 (e.g., audio, mp3, etc.), and generating an advertisement (e.g., the advertisement 300 of FIG. 3) that is displayed to the user 110 when the media content 114 is streamed to the user 110.

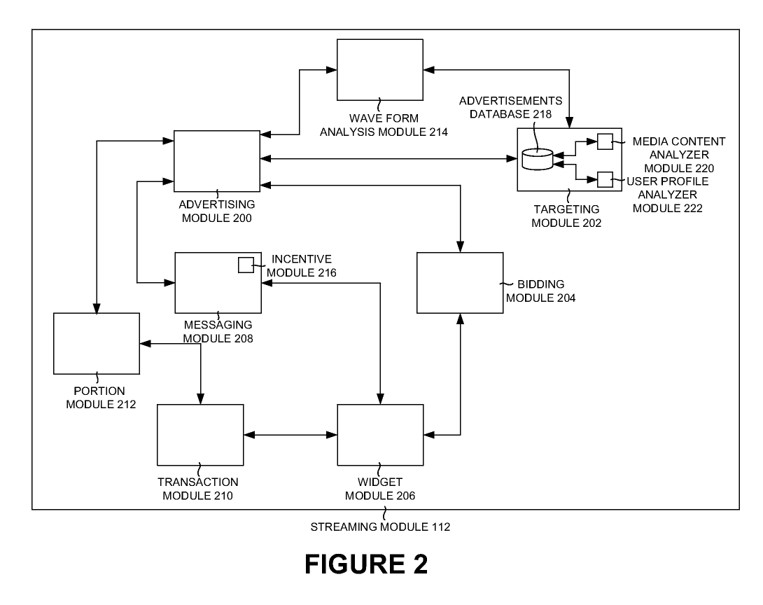

In another embodiment, the method includes generating an advertisement (e.g., the advertisement 300 of FIG. 3) that is targeted (e.g., using the targeting module 202 of FIG. 2) toward a user (e.g., the user 110 of FIG. 1) playing a streaming media content from a central server (e.g., the central server 102 of FIG. 1) based on a characteristic of a media content 114 currently being streamed and a meta-data of the advertisement 300, and providing a bidding mechanism (e.g., using the bidding module 204 of FIG. 2) to advertisers to compete for placement of the advertisement 300 in streams of the media content 114 to the user 110 and to other users.

In yet another embodiment, the system includes a central server (e.g., the central server 102 of FIG. 1) to stream a media content (e.g., the media content 114 of FIG. 1) to a user (e.g., the user 110 of FIG. 1) and to select an advertisement (e.g., the advertisement 300 of FIG. 3) to be simultaneously displayed with the media content 114 (e.g., audio, video, etc.) being streamed, a content database (e.g., the content database 106 of FIG. 1) associated with the central server 102 having the media content 114 and other media content of artists (e.g., Bryan Adams, etc.) and media labels (e.g., brands, etc.) based on a request of a user (e.g., the user 110 of FIG. 1) of a social community environment (e.g., the social community environment 100 of FIG. 1), and a client device (e.g., the client device 108 of FIG. 1) to display an advertisement (e.g., the advertisement 300 of FIG. 3) that may be displayed to the user 110 when the media content 114 (e.g., audio, video, etc.) may be streamed to the user 110 without requiring consideration from the user 110 to access the media content 114.

FIG. 1 is system view of a user (e.g., the user 110 of FIG. 1) selecting the media data of his/her interest through a client device (e.g., the client device 108 of FIG. 1) through a network (e.g., the network 104 of FIG. 1), according to one embodiment. Particularly, FIG. 1 illustrates a social community environment 100, a central server 102, a network 104, a content database 106, a client device 108, a user 110, a streaming module 112, media content 114, a matching module 116, a financial module 118, a delivery module 120, and a communication module 122, according to one embodiment.

The social community environment 100 may be a community in which users share their interests (e.g., common interest in music, videos, etc.) with other users having similar or different interests online. The central server 102 may be an application and/or device that may perform services to the client devices. The central server 102 may consist of a set of high-speed computers that may store applications and/or data files shared by many different people on the network 104 (e.g., an internet, etc.). The network 104 may be a local area network, a wide area network, an internet network etc. where the user 110 communicates with the central server 102 through the social community environment 100 (e.g., using the communication module 122 of FIG. 1) for the media content 114 of his/her interest.

The content database 106 may be collection of content data which may include media data (e.g., audio data, video data, etc.). The client device 108 may be data processing system (e.g., computer, laptop, mobile, etc.). The user 110 may be person, patron etc. who may want to access the media data of their interest. The streaming module 112 may stream media data (e.g., audio data, video data, etc.) to the client device 108. The media content 114 may be audio, video, etc. stored in the content database 106. The matching module 116 may match advertisements (e.g., may be good and/or service, etc.) with the requested media data (e.g., artist, album, a track etc.) along with the interests associated with the user 110 (e.g., the person interested in media data). The financial module 118 may manage transactions associated with media data, ads, etc. The delivery module 120 may transmit the requested media data (e.g., song, movie, etc.) when transaction associated with requested media data is completed. The communication module 122 of the streaming module 112 may provide communication with the central server 102 through the network 104.

In example embodiment, the user 110 may select the interested media content in the client device 108 through the network 104. The media data may be streamed to the user 110 by communicating with the central server 102 when the user 110 requests the media data through the social community environment 100. The central server 102 may communicate with the content database 106 to stream the media data through the social community environment 100.

In one embodiment, the media content 114 may be selected from the content database 106 having content of artists and/or media labels based on a request of the user 110 of the social community environment 100. The media content 114 (e.g., audio data, video data, artists, etc.) may be streamed (e.g., using the streaming module 112 of FIG. 1) from the central server 102 associated with the central database to the user 110 without requiring consideration of the user 110 to access the media content 114, and an advertisement (e.g., the advertisement 300 of FIG. 3) that may be displayed to the user 110 may be generated (e.g., using the matching module 116 of FIG. 1) when the media content 114 (e.g., songs, movies, ads, etc.) may be streamed (e.g., using the streaming module 112 of FIG. 1) to the user 110.

A server-side media player (e.g., the server-side media player 350 of FIG. 3) may be provided associated with the social community environment 100 that may enable the user 110 to stream the media content 114 to the client device 108 (e.g., mobile device, a desktop computer, a telephone, an Internet appliance, and/or an automobile etc.). A widget of the server-side media player 350 that may be embeddable across different websites (e.g., using the widget module 206 of FIG. 2) such that users of the different websites may be able to stream the media content 114 (e.g., using the streaming module 112 of FIG. 1) along with the advertisement 300 to their respective client devices (e.g., mobile device, a desktop computer, a telephone, an Internet appliance, and/or an automobile etc.) from the central server 102 through the different websites.

The central server 102 may stream (e.g., using the streaming module 112 of FIG. 1) the media content 114 to the user 110 and may provide the advertisement 300 to be simultaneously displayed with the media content 114 being streamed, the content database 106 associated with the central server 102 having the media content 114 and/or other media content of artists and/or media labels based on a request of the user 110 of the social community environment 100. The client device 108 may display the advertisement 300 that may be displayed to the user 110 when the media content 114 may be streamed to the user 110 without requiring consideration from the user 110 to access the media content 114.

The matching module 116 of the central server 102 may select a good and/or a service being marketed in the advertisement 300 based on a closest match between a meta-data and/or an artist, an album, a track, a genre, a type, and/or a tempo of the media content 114 and based on interests (e.g., my interests 304 of FIG. 3) defined in a user profile (e.g., using the user profile analyzer module 222) associated with the user 110.

The financial module 118 of the central server 102 may process a transaction in which the user 110 may purchase a downloadable copy of the media content 114 being streamed. The delivery module 120 of the central server 102 may transmit the downloadable copy of the streaming media content to the client device 108 (e.g., mobile device, a desktop computer, a telephone, an Internet appliance, and/or an automobile etc) when the transaction may be complete.

FIG. 2 is an exploded view of streaming module illustrated in FIG. 1, according to one embodiment. Particularly, FIG. 2 illustrates a streaming module 112, an advertising module 200, a targeting module 202, a bidding module 204, a widget module 206, a messaging module 208, a transaction module 210, a portion module 212, a wave form analysis module 214, an incentive module 216, an advertisements database 218, a media content analyzer module 220, and a user profile analyzer module 222, according to one embodiment.

The advertising module 200 may stream the advertisements matching (e.g., using the matching module 116 of FIG. 1) with the media content 114 the user 110 had requested. The targeting module 202 may target advertisements related to the media content 114, interests, etc. associated to a particular user who requests for the media content 114. The bidding module 204 may enable entities/organizations to bid against each other on placement and click. The widget module 206 may enable placement of widgets of server-side media player 350 in other websites. The messaging module 208 may send a message to the user 110 after the media content 114 is streamed and advertisements are displayed. The transaction module 210 may enable the transaction between the user 110, the organizations providing advertisement, the social community environment 100 and/or the central server 102.

The portion module 212 may enable the streaming module 112 to stream the advertisement 300 during beginning portion, middle portion, end portion, and/or arbitrary portion of the streaming media content. The portion module 212 may also enable allocating a portion of revenue to the organizations participating in bid. The wave form analysis module 214 may orchestra a visual motion and/or color scheme of the advertisement 300 based on a tempo, a harmony, a rhythm, and/or a melody of the media content. The incentive module 216 may provide additional incentives for the user 110 to respond to the advertisements. The advertisements database 218 may include different advertisements that may be displayed based on matching meta-data, etc based on the interest of the user 110. The media content analyzer module 220 may analyze media content requested by the user 110 to generate the advertisement 300 matching with the media data. The user profile analyzer module 222 may analyze the profile of the user 110 for targeting advertisements, media contents, etc.

In an example embodiment, the advertising module 200 may communicate with the targeting module 202 for streaming the advertisement 300 in the advertisements database 218 using the media content analyzer module 220 and the user profile analyzer module 222. The advertising module 200 may communicate with the bidding module 204, the messaging module 208, the wave form analysis module 214 and the portion module 212 directly and with transaction module 210 and with transaction module 210, and the widget module 206.

In one embodiment, a good and/or a service being marketed in the advertisement 300 may be selected based on an artist, an album, a track, a genre, a type, and/or a tempo of the media content 114 and based on interests (e.g., my interests 304 of FIG. 3) defined in a user profile associated with the user 110. A bidding system (e.g., bidding module 204 of FIG. 2) in which different organizations may provide advertisements bid against each other on placement and click through of their advertisements in a specific ones of the media content 114 of artists and at specific locations of the media content 114 of artists. The bidding system in which the different organizations select different profiles of users of the social community environment 100 to target delivery of their advertisements. The advertisement 300 (e.g., using the advertising module 200) that may be displayed may be determined based on an analysis of a click through rate on the advertisement 300 by the users of the social community environment 100 and/or a transaction rate of the users of the social community environment 100 to whom the advertisement 300 may be displayed. The portion (e.g., using the portion module 212 of FIG. 2) of consideration of an organization may be allocated providing the advertisement 300 (e.g., using the advertising module 200) to an artist and/or a media label associated with the media content 114, and to the social community environment 100 associated with the user 110.

An electronic message may be sent to the user 110 after the media content 114 may have been streamed and the advertisement 300 may be displayed having an additional incentive (e.g., using the incentive module 216 of FIG. 2) to respond to the advertisement 300. The advertisement 300 may be streamed to a client device (e.g., the client device 108 of FIG. 1) that may be a mobile device, a desktop computer, a telephone, an Internet appliance, and/or an automobile.

A transaction (e.g., using the transaction module 210 of FIG. 2) may be processed in which the user 110 may purchase a downloadable copy of the media content 114, and the downloadable copy of the media content 114 may be communicated to the client device 108 (e.g., mobile device, a desktop computer, a telephone, an Internet appliance, and/or an automobile etc) when the transaction is complete. Different advertisements may be selected to be displayed after the advertisement 300 when the media content 114 is still being streamed to the client device 108 (e.g., mobile device, a desktop computer, a telephone, an Internet appliance, and/or an automobile etc) such that the different advertisement (e.g., advertisement 300) may be targeted towards a beginning portion, a middle portion, an ending portion, and/or an arbitrary portion of the streaming of the media content 114.

A visual motion and/or color scheme of the advertisement 300 based on a tempo, a harmony, a rhythm, and/or a melody of the media content 114 may be orchestrated through a wave form analysis (e.g., the wave form analysis module 214 of FIG. 2) of the media content 114. The advertisement 300 that is targeted (e.g., using the target module) toward a user 110 may be generated playing a streaming media content from a central server (e.g., the central server 102 of FIG. 1) based on a characteristic of a media content (e.g., the media content of FIG. 1) currently being streamed and/or a meta-data of the advertisement 300. A bidding mechanism may be provided (e.g., using the bidding module 204 of FIG. 2) to advertisers to compete for placement of the advertisement 300 in streams of the media content 114 to the user 110 and to other users.

A good and/or a service being marketed in the advertisement 300 may be selected based on a closest match (e.g., using the matching module 116 of FIG. 1) between the meta-data and/or an artist, an album, a track, a genre, a type, and/or a tempo of the streaming media content and/or based on interests defined in a user profile (e.g., using the user profile analyzer module 222 of FIG. 2) module associated with the user 110. An electronic message may be sent to the user 110 after the streaming media content has been sent having an additional incentive (e.g., the incentive module 216 of FIG. 2) to respond to the advertisement 300.

A transaction may be processed (e.g., using the transaction module 210 of FIG. 2) in which the user 110 may purchase a downloadable copy of the streaming media content, and the downloadable copy of the streaming media content may be communicated to a client device (e.g., the client device 108 of FIG. 1) when the transaction (e.g., using the transaction module 210) is complete. A different advertisement may be selected to be displayed (e.g., using the advertising module 200 of FIG. 2) after the advertisement 300 when the streaming media content (e.g., streaming module 112) may be still being sent to the user 110 such that the different advertisement may be targeted towards a beginning portion, a middle portion, an ending portion, and/or an arbitrary portion of the streaming media content. A visual motion and/or color scheme of the advertisement 300 based on a tempo, a harmony, a rhythm, and/or a melody of the streaming media content may be orchestrated through a wave form analysis (e.g., using the wave form analysis module 214 of FIG. 2) of the streaming media content. An electronic message may be sent to the user 110 after the media content 114 has been sent having an additional incentive (e.g., using the incentive module 216 of FIG. 2) to respond to the advertisement 300.

FIG. 3 is a user interface view of server-side media player 350, according to one embodiment. Particularly, FIG. 3 illustrates an advertisement 300, your play list 302, my interests 304, a visual display advertisement 306, and a current song indicator 308, according to one embodiment.

The advertisement 300 may be displayed in the server-side media player 350. The advertisement 300 may be created by the media content analyzer module 220 and/or the user profile analyzer module 222. The “your play list” 302 may be a list of media data that the user 110 may have created. The “my interests” 304 may be the interests specified by the user 110 in the profile. The visual display advertisement 306 may be advertisement which is visual (e.g., video ads, etc.). The current song indicator 308 may indicate the song currently being played along with the timing status of the song. The server-side media player 350 may be a server side application for playing the media content 114 on different websites.

In example embodiment, the user interface view may display the server-side media player 350 which may show John's profile along with the current song (e.g., Marky Mack) being played. The user profile (e.g., John's profile) may include the playlists (e.g., the “your playlists” 302 of FIG. 3), the user interests (e.g., my interests 304 of FIG. 3), top streams, the advertisement 300, the visual display advertisement 306, the current song indicator 308, etc. The “your playlist” 302 may display Jimmy Hendrickws, Rosetta Stones, Marky Mack. The “my interest” 304 may display exercise, basket ball, hiphop, etc. The advertisement 300 may display Aerobics class, discount AT, Acme Gym $15! related to the current playing track.

In one embodiment, the advertisement 300 may be displayed in a drop-down banner adjacent to a location in the social community environment 100 in which the user 110 selects the media content 114.

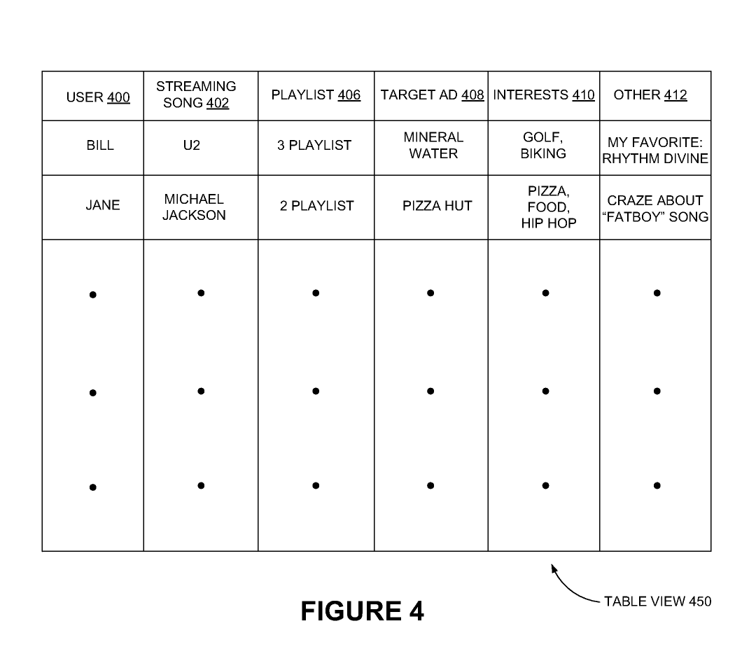

FIG. 4 is a table view 450 of illustrating various fields such as streaming data, playlist, target ad, etc., according to one embodiment. Particularly, FIG. 4 illustrates a user field 402, a streaming song field 404, a playlist field 406, a target ad field 408, interests field 410, and other field 412, according to one embodiment.

The user field 402 may illustrate the user 110 (e.g., Bill, Jane, as illustrated in FIG. 4) who is streaming the media data from the network 104. The streaming song field 404 may illustrate the song that is currently being streamed by the particular user. The playlist field 406 may state the number of playlists the user 110 is currently having. The target ad field 408 may display the advertisement related to the song, interest etc. that may be streamed along with the streaming song. The interests field 410 may display the interests of the particular user. The other field 412 may display other aspects (e.g., favorites, craze, etc.) associated with particular user.

In an example embodiment, the FIG. 4 illustrates various fields according to one embodiment. The user field 402 column may display Bill in first row and Jane in second row. The streaming song field 404 column may display U2 in first row associated with user Bill and Michael Jackson's song streamed associated with user Jane in second row. The playlist field 406 column may display three playlists and two playlists associated with the users Bill and Jane respectively. The target ad 408 column may display mineral water advertisement to the user Bill associated with his streaming song U2, interests of Bill etc. on the first row and Pizza hut advertisement to the user Jane associated with her streaming song of Michael Jackson, interests of Jane etc. The interests field 410 may display interests such as Golf, Biking associated with the user Bill and interests such as Pizza, Food, Hip hop etc. associated with the user Jane. The other field 412 may display “rhythm divine” as favorite of Bill, craze on song as “Fatboy” for Jane, according to one embodiment.

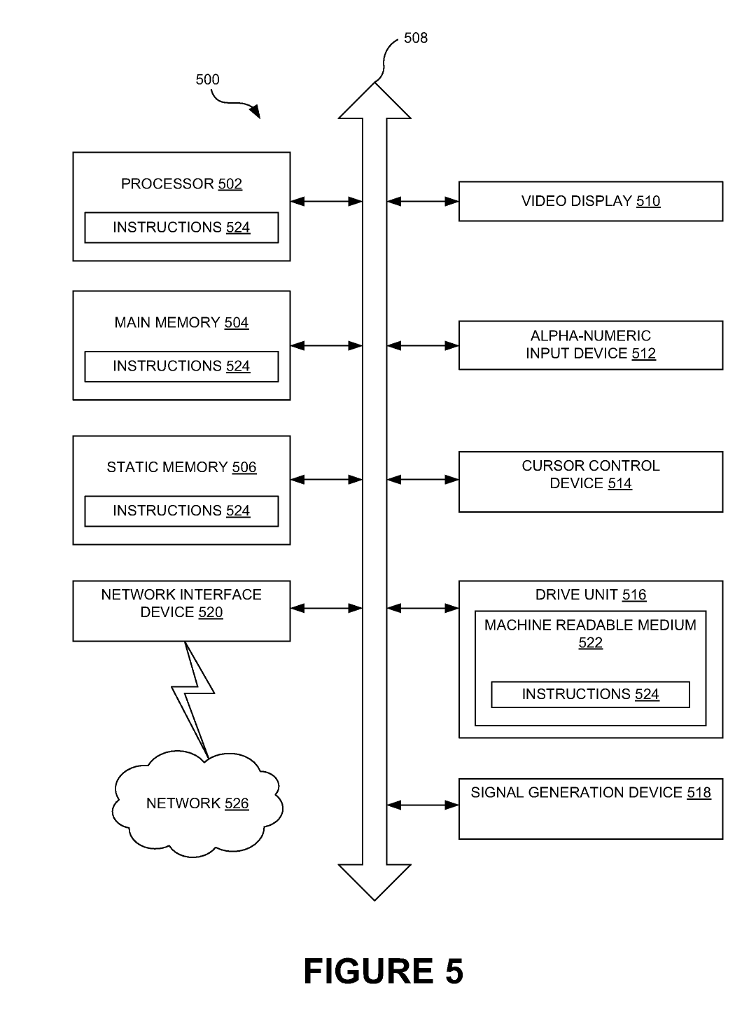

FIG. 5 is a diagrammatic system view 500 of a data processing system in which any of the embodiments disclosed herein may be performed, according to on embodiment. Particularly, the diagrammatic system view 500 of FIG. 5 illustrates a processor 502, a main memory 504, a static memory 506, a bus 508, a video display 510, an alpha-numeric input device 512, a cursor control device 514, a drive unit 516, a signal generation device 518, a network interface device 520, a machine readable medium 522, instructions 524, and a network 526, according to one embodiment.

The diagrammatic system view 500 may indicate a personal computer and/or the data processing system in which one or more operations disclosed herein are performed. The processor 502 may be a microprocessor, a state machine, an application specific integrated circuit, a field programmable gate array, etc. (e.g., Intel® Pentium® processor). The main memory 504 may be a dynamic random access memory and/or a primary memory of a computer system.

The static memory 506 may be a hard drive, a flash drive, and/or other memory information associated with the data processing system. The bus 508 may be an interconnection between various circuits and/or structures of the data processing system. The video display 510 may provide graphical representation of information on the data processing system. The alpha-numeric input device 512 may be a keypad, a keyboard and/or any other input device of text (e.g., a special device to aid the physically handicapped).

The cursor control device 514 may be a pointing device such as a mouse. The drive unit 516 may be the hard drive, a storage system, and/or other longer term storage subsystem. The signal generation device 518 may be a bios and/or a functional operating system of the data processing system. The network interface device 520 may be a device that performs interface functions such as code conversion, protocol conversion and/or buffering required for communication to and from the network 526. The machine readable medium 522 may provide instructions on which any of the methods disclosed herein may be performed. The instructions 524 may provide source code and/or data code to the processor 502 to enable any one or more operations disclosed herein.

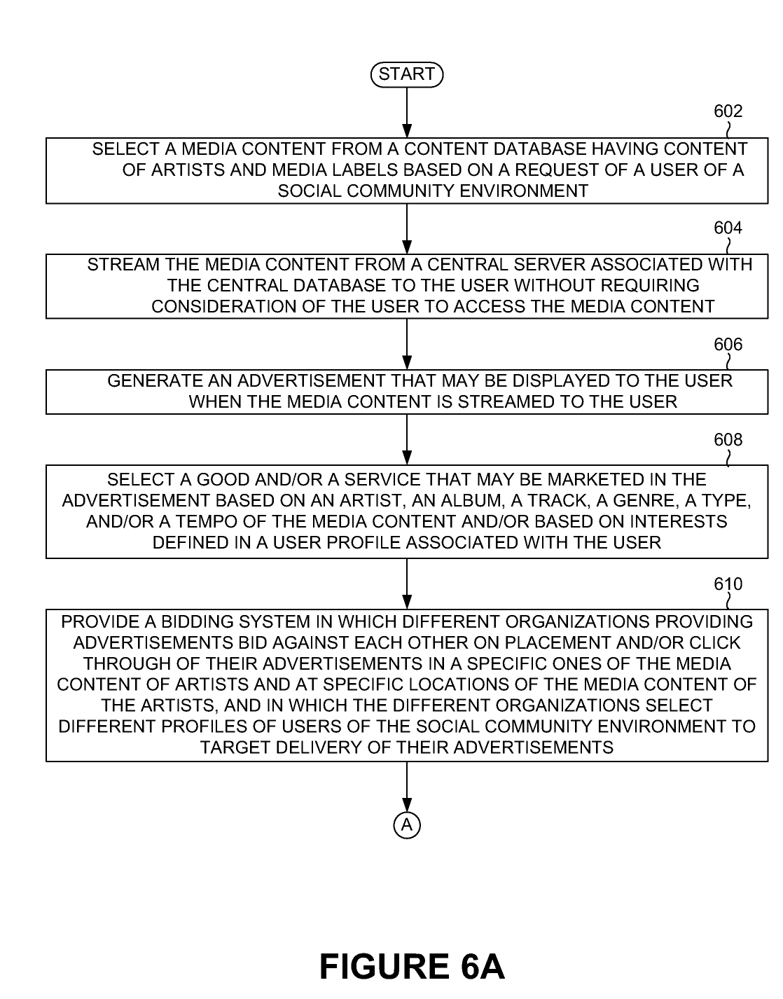

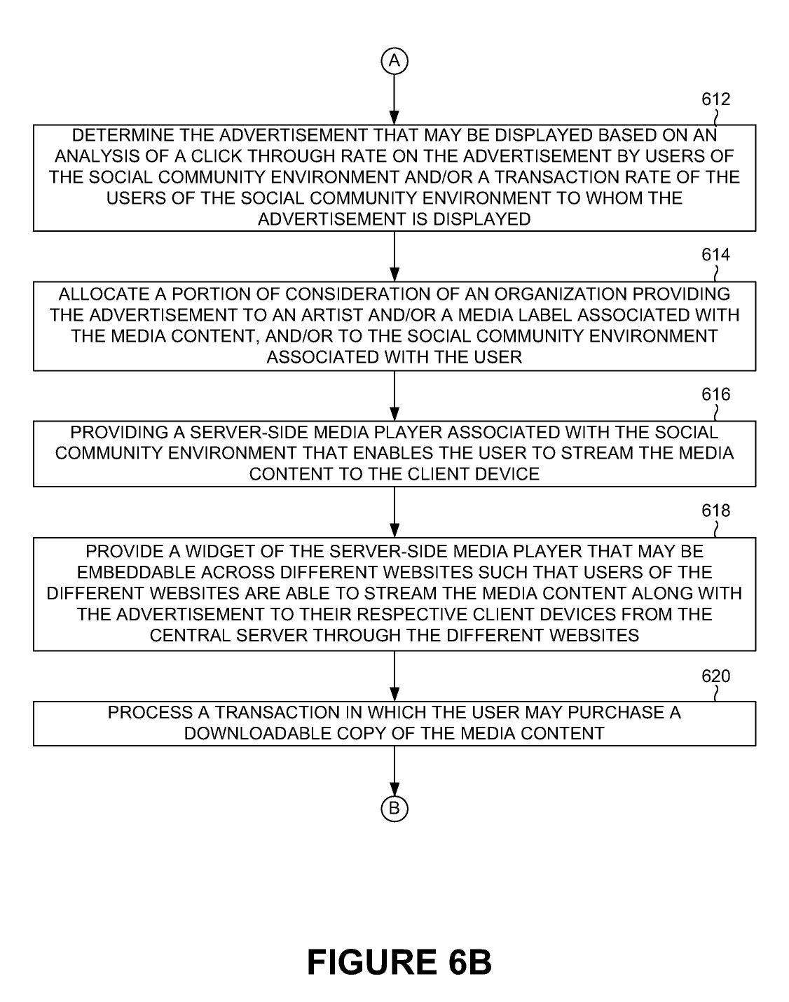

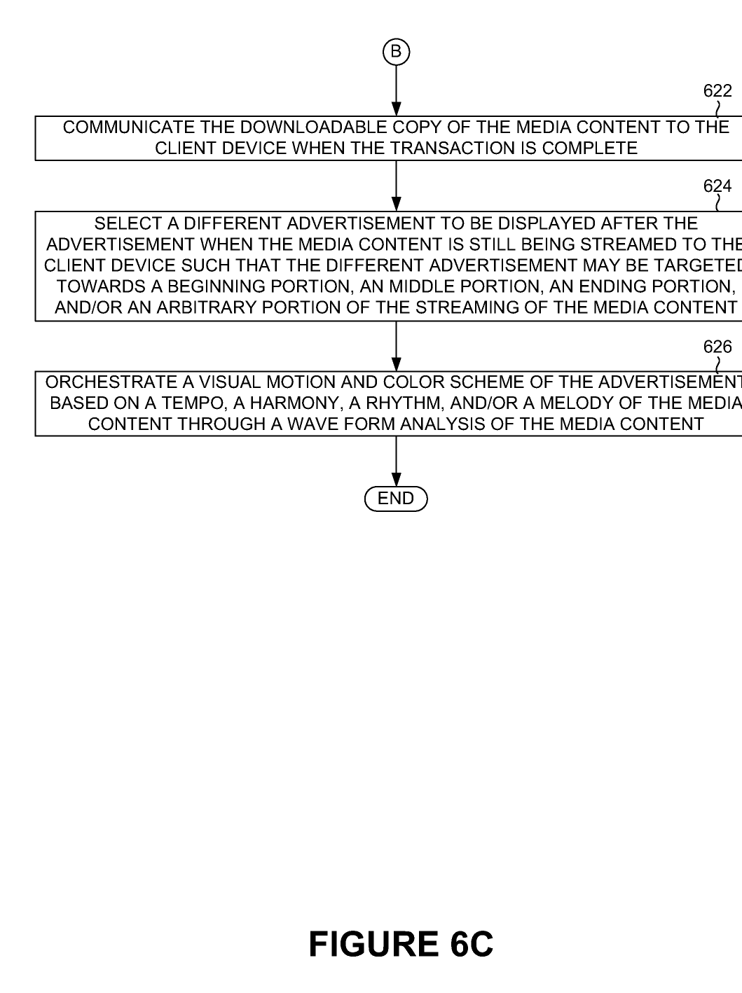

FIG. 6 is a process flow of determining advertisements that may be displayed based on analysis of a click through rate on the advertisements by users of a social community environment, according to one embodiment. In operation 602, media content (e.g., the media content 114 of FIG. 1) may be selected from a content database (e.g., the content database 106 of FIG. 1) having content of artists and/or media labels based on a request of a user (e.g., the user 110 of FIG. 1) of a social community environment (e.g., the social community environment 100 of FIG. 1). In operation 604 the media content 114 may be streamed (e.g., using the streaming module 112 of FIG. 1) from a central server (e.g., the central server 102 of FIG. 1) associated with the central database to the user 110 without requiring consideration of the user 110 to access the media content 114.

In operation 606, an advertisement (e.g., the advertisement 300 of FIG. 1) that may be displayed to the user may be generated (e.g., using the advertising module 200 of FIG. 2) when the media content 114 is streamed to the user 110. In operation 608, a good and/or a service being marketed in the advertisement 300 may be selected based on an artist, an album, a track, a genre, a type, and/or a tempo of the media content 114 (e.g., using the media content analyzer module 220 of FIG. 2) and/or based on interests (e.g., the my interests 304 of FIG. 1) defined in a user profile (e.g., using the user profile analyzer module 222 of FIG. 2) associated with the user 110. In operation 610, a bidding system (e.g., the bidding module 204 of FIG. 2) may be provided in which different organizations provide advertisements bid against each other on placement and click through of their advertisements in a specific ones of the media content 114 of the artists and/or at specific locations of the media content 114 of artists, and in which the different organizations select different profiles of users of the social community environment 100 to target delivery of their advertisements (e.g., using the advertising module 200 of FIG. 2).

FIG. 6B is a continuation of process flow of FIG. 6A, illustrating additional operations, according to one embodiment. In operation 612, the advertisement 300 that may be displayed based on an analysis of a click through rate on the advertisement 300 by users of the social community environment 100 and/or a transaction rate of users of the social community environment 100 may be determined (e.g., using the targeting module 202 of FIG. 2) to whom the advertisement is displayed. In operation 614, a portion of consideration of an organization may be allocated (e.g., using the transaction module 210 of FIG. 2) providing the advertisement 300 to an artist and/or a media label associated with the media content 114, and/or to the social community environment 100 associated with the user 110.

An electronic message may be sent to the user (e.g., using the messaging module 208 of FIG. 2) after the media content 114 is streamed (e.g., using the streaming module 112 of FIG. 2) and the advertisement 300 may be displayed having an additional incentive (e.g., using the incentive module 216 of FIG. 2) to respond to the advertisement. The advertisement may be displayed in a drop-down banner (e.g., as illustrated in FIG. 3) adjacent to a location in the social community environment 100 in which the user 110 selected the media content 114. The advertisement may be streamed (e.g., using the streaming module 112 of FIG. 1) to a client device (e.g., the client device 108 of FIG. 1) that may be a mobile device, a desktop computer, a telephone, an Internet appliance, and/or an automobile, etc.

In operation 616, a server-side media player (e.g., the server-side media player 350 of FIG. 3) associated with the social community environment 100 may be provided that may enable the user 110 to stream the media content 114 to the client device 108. In operation 618, a widget of the server-side media player 350 may be provided that may be embeddable across different websites (e.g., using the widget module 206 of FIG. 2) such that users of the different websites may be able to stream the media content 114 along with the advertisement 300 to their respective client devices from the central server 102 through the different websites.

FIG. 6C is a continuation of process flow of FIG. 6B, illustrating additional operations, according to one embodiment. In operation 620, a transaction may be processed (e.g., using the transaction module 210 of FIG. 2) in which the user 110 may purchase a downloadable copy of the media content 114. In operation 622, the downloadable copy of the media content 114 may be communicated to the client device 108 when the transaction (e.g., using the transaction module 210 of FIG. 2) is complete. In operation 624, a different advertisement to be displayed may be selected after the advertisement 300 when the media content 114 is still being streamed (e.g., using the streaming module 112 of FIG. 1) to the client device 108 such that the different advertisement may be targeted (e.g., using the targeting module 202 of FIG. 2) toward a beginning portion, an middle portion, an ending portion, and/or an arbitrary portion (e.g., using the portion module 212 of FIG. 2) of the streaming of the media content 114. In operation 626, a visual motion and/or color scheme of the advertisement based on a tempo, a harmony, a rhythm, and/or a melody of the media content 114 may be orchestrated through a wave form analysis (e.g., using the wave form analysis module 214 of FIG. 2) of the media content 114.

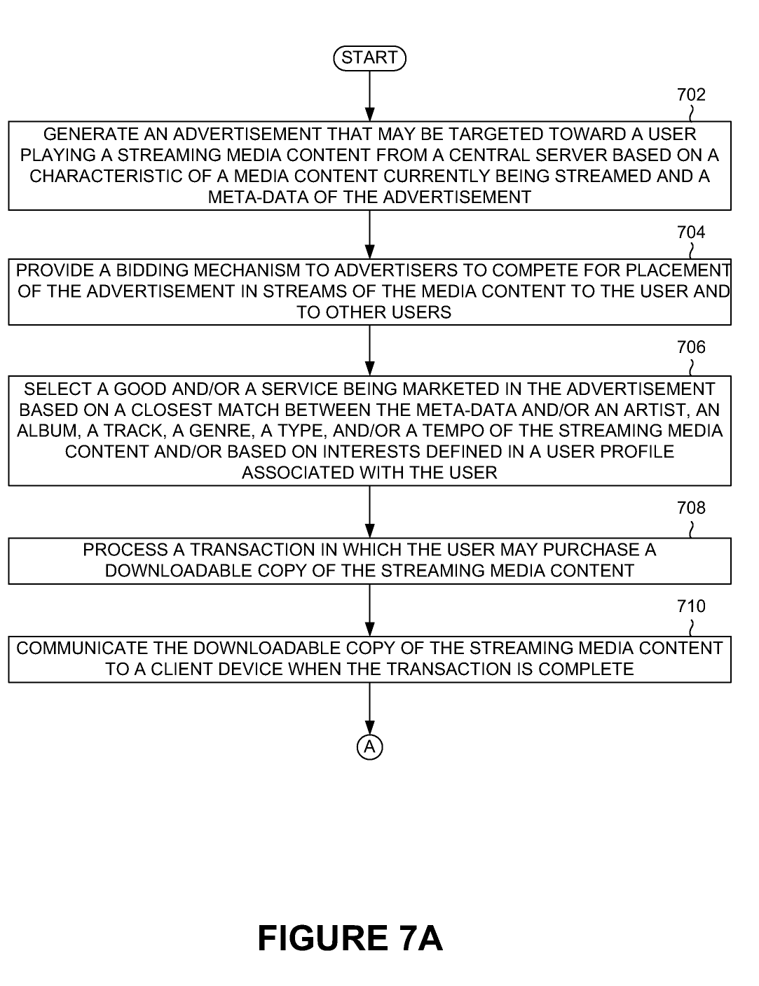

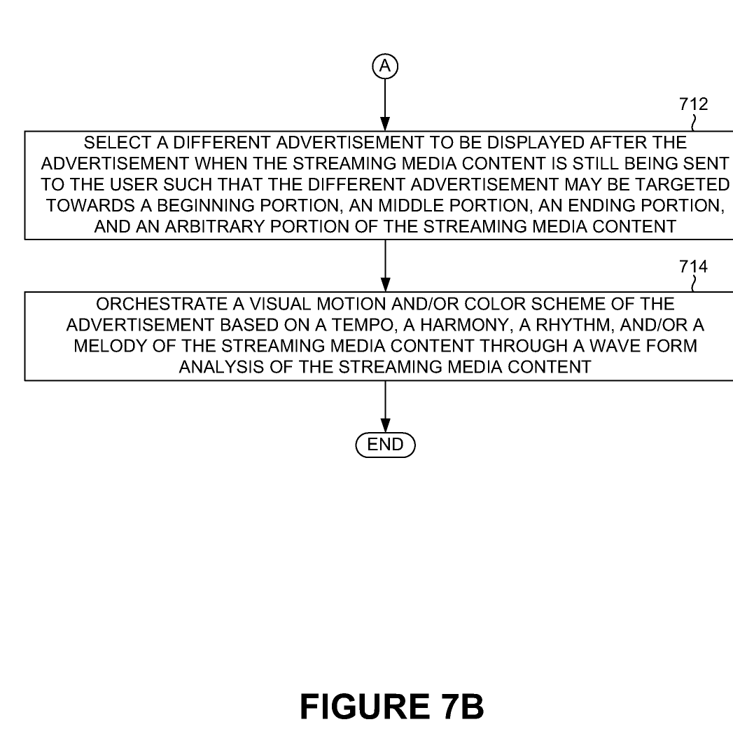

FIG. 7A is a process flow of generating an advertisement (e.g., the advertisement 300 of FIG. 3) based on a streaming media data associated with a user (e.g., the user 110 of FIG. 1), according to one embodiment. In operation 702, the advertisement 300 may be generated (e.g., using the advertising module 200 of FIG. 2) that may be targeted (e.g., using the targeting module 202 of FIG. 2) toward the user 110 playing a streaming media content from a central server (e.g., the central server 102 of FIG. 1) based on a characteristic of a media content (e.g., the media content 114 of FIG. 1) currently being streamed and/or a meta-data of the advertisement. In operation 704, a bidding mechanism may be provided (e.g., using the bidding module 204 of FIG. 2) to advertisers to compete for placement of the advertisement 300 in streams of the media content 114 to the user 110 and to other users. In operation 706, a good and/or a service being marketed in the advertisement 300 may be selected based on a closest match (e.g., using the matching module 116 of FIG. 1) between the meta-data and an artist, an album, a track, a genre, a type, and/or a tempo of the streaming media content (e.g., using the media content analyzer module 220 of FIG. 2) and/or based on interests defined in a user profile (e.g., using the user profile analyzer module 222 of FIG. 2) associated with the user 110.

An electronic message may be sent to the user 110 (e.g., using the messaging module 208 of FIG. 2) after the streaming media content is sent having an additional incentive to respond to the advertisement 300 (e.g., using the incentive module 216 of FIG. 2). In operation 708, a transaction may be processed (e.g., using the transaction module 210 of FIG. 2) in which the user 110 may purchase a downloadable copy of the streaming media content.

FIG. 7B is a continuation of process flow of FIG. 7A, illustrating additional operations, according to one embodiment. In operation 710, the downloadable copy of the streaming media content may be communicated to a client device (e.g., the client device 108 of FIG. 1) when the transaction is complete (e.g., using the transaction module 210 of FIG. 2). In operation 712, a different advertisement to be displayed may be selected after the advertisement 300 when the streaming media content is still being sent to the user 110 such that the different advertisement may be targeted (e.g., using the targeting module 202 of FIG. 2) toward a beginning portion, an middle portion, an ending portion, and/or an arbitrary portion of the streaming media content (e.g., using the portion module 212 of FIG. 2). In operation 714, a visual motion and/or color scheme of the advertisement based on a tempo, a harmony, a rhythm, and/or a melody of the streaming media content may be orchestrated through a wave form analysis (e.g., using the wave form analysis module of FIG. 2) of the streaming media content.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry).

For example, the streaming module 112, the matching module 116, the financial module 118, the delivery module 120, the communication module 122, the streaming module 112, the advertising module 200, the targeting module 202, the bidding module 204, the widget module 206, the messaging module 208, the transaction module 210, the portion module 212, the wave form analysis module 214, the incentive module 216, the media content analyzer module 220, and the user profile analyzer module 222 of FIG. 1-7B may be enabled using software and/or using transistors, logic gates, and electrical circuits (e.g., application specific integrated ASIC circuitry) such as a streaming circuit, a matching circuit, a financial circuit, a delivery circuit, a communication circuit, a streaming circuit, an advertising circuit, a targeting circuit, a bidding circuit, a widget circuit, a messaging circuit, a transaction circuit, a portion circuit, a wave form analysis circuit, an incentive circuit, a media content analyzer circuit, and a user profile analyzer circuit, and other circuits.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
selecting a media content from a content database having content of a plurality of artists and media labels based on a request of a user of a social community environment;
streaming the media content from a central server associated with the central database to the user without requiring consideration of the user to access the media content; and
generating an advertisement that is displayed to the user when the media content is streamed to the user.

2. The method of claim 1 further comprising:
selecting at least one of a good and a service being marketed in the advertisement based on at least one of an artist, an album, a track, a genre, a type, and a tempo of the media content and based on interests defined in a user profile associated with the user.

3. The method of claim 2 further comprising:
providing a bidding system in which different organizations providing advertisements bid against each other on placement and click through of their advertisements in a specific ones of the media content of the plurality of artists and at specific locations of the media content of the plurality of artists, and in which the different organizations select different profiles of users of the social community environment to target delivery of their advertisements;
determining the advertisement that is displayed based on an analysis of at least one of a click through rate on the advertisement by a plurality of users of the social community environment and a transaction rate of the plurality of users of the social community environment to whom the advertisement is displayed; and
allocating a portion of consideration of an organization providing the advertisement to at least one of an artist and a media label associated with the media content, and to the social community environment associated with the user.

4. The method of claim 1 wherein an electronic message is sent to the user after the media content is streamed and the advertisement is displayed having an additional incentive to respond to the advertisement.

5. The method of claim 1 wherein the advertisement is displayed in a drop-down banner adjacent to a location in the social community environment in which the user selected the media content.

6. The method of claim 5 wherein the advertisement is streamed to a client device that is at least one of a mobile device, a desktop computer, a telephone, an Internet appliance, and an automobile.

7. The method of claim 6 further comprising:
providing a server-side media player associated with the social community environment that enables the user to stream the media content to the client device; and
providing a widget of the server-side media player that is embeddable across different websites such that users of the different websites are able to stream the media content along with the advertisement to their respective client devices from the central server through the different websites.

8. The method of claim 7 further comprising:
processing a transaction in which the user purchases a downloadable copy of the media content; and
communicating the downloadable copy of the media content to the client device when the transaction is complete.

9. The method of claim 7 further comprising:
selecting a different advertisement to be displayed after the advertisement when the media content is still being streamed to the client device such that the different advertisement is targeted toward at least one of a beginning portion, an middle portion, an ending portion, and an arbitrary portion of the streaming of the media content.

10. The method of claim 1 further comprising:
orchestrating a visual motion and color scheme of the advertisement based on a tempo, a harmony, a rhythm, and a melody of the media content through a wave form analysis of the media content.

11. The method of claim 1 in a form of a machine-readable medium embodying a set of instructions that, when executed by a machine, causes the machine to perform the method of claim 1.

12. A method comprising:
generating an advertisement that is targeted toward a user playing a streaming media content from a central server based on a characteristic of a media content currently being streamed and a meta-data of the advertisement; and
providing a bidding mechanism to advertisers to compete for placement of the advertisement in streams of the media content to the user and to other users.

13. The method of claim 12 further comprising:
selecting at least one of a good and a service being marketed in the advertisement based on a closest match between the meta-data and at least one of an artist, an album, a track, a genre, a type, and a tempo of the streaming media content and based on interests defined in a user profile associated with the user.

14. The method of claim 13 wherein an electronic message is sent to the user after the streaming media content is sent having an additional incentive to respond to the advertisement.

15. The method of claim 12 further comprising:
processing a transaction in which the user purchases a downloadable copy of the streaming media content; and
communicating the downloadable copy of the streaming media content to a client device when the transaction is complete.

16. The method of claim 12 further comprising:
selecting a different advertisement to be displayed after the advertisement when the streaming media content is still being sent to the user such that the different advertisement is targeted toward at least one of a beginning portion, an middle portion, an ending portion, and an arbitrary portion of the streaming media content; and
orchestrating a visual motion and color scheme of the advertisement based on a tempo, a harmony, a rhythm, and a melody of the streaming media content through a wave form analysis of the streaming media content.

17. A system, comprising:
a central server to stream a media content to a user and to select an advertisement to be simultaneously displayed with the media content being streamed;
a content database associated with the central server having the media content and other media content of a plurality of artists and media labels based on a request of a user of a social community environment; and
a client device to display the advertisement that is displayed to the user when the media content is streamed to the user without requiring consideration from the user to access the media content.

18. The system of claim 17 further comprising:
a matching module of the central server to select at least one of a good and a service being marketed in the advertisement based on a closest match between a meta-data and at least one of an artist, an album, a track, a genre, a type, and a tempo of the media content and based on interests defined in a user profile associated with the user.

19. The system of claim 18 wherein an electronic message is sent to the user after the media content is sent having an additional incentive to respond to the advertisement.

20. The system of claim 19 further comprising:
a financial module of the central server to process a transaction in which the user purchases a downloadable copy of the media content being streamed; and
a delivery module of the central server to transmit the downloadable copy of a streaming media content to the client device when the transaction is complete.
